(19) United States
(12) Patent Application Publication
(10) Pub. No.: US 2017/0012729 A1
(43) Pub. Date: Jan. 12, 2017

(54) TIMING ACQUISITION TECHNIQUES FOR MOBILE STATION IN WIRELESS NETWORK

(71) Applicant: NOKIA SOLUTIONS AND NETWORKS OY, Espoo (FI)

(72) Inventors: Timothy THOMAS, Palatine, IL (US); Yohannes SOLICHIEN, Arlington Heights, IL (US)

(21) Appl. No.: 14/795,400

(22) Filed: Jul. 9, 2015

(51) Int. Cl. H04J 11/00; H04W 56/00

(52) U.S. Cl. CPC H04J 11/0073; H04W 56/001; H04J 2011/0096

(57) ABSTRACT

An example technique may include receiving, by a mobile station from a cell, a first block of symbols and a second block of symbols, each of the first and second blocks of symbols including a plurality of contiguous segments that include a plurality of symbols, performing, by the mobile station, a short correlation of each segment of the first block of symbols with a corresponding segment of the second block of symbols to obtain a plurality of segment correlation results, determining a block correlation result for the first block of symbols and the second block of symbols based on summing at least a first subset of the segment correlation results and subtracting a second subset of the segment correlation results.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed.

Mobile stations (e.g., smart phones or other mobile devices or wireless devices) may perform timing acquisition to obtain information that may be used to communicate with a cell or base station. In one illustrative example, a mobile station may use an acquisition procedure that may include, for example, receiving synchronization signals from one or more nearby cells. From a primary synchronization signal (PSS), for example, a mobile station may discover timing information such as symbol timing. From secondary synchronization signals (SSS), the mobile station may determine further information for a cell, such as, for example, frame timing, a physical cell ID (identifier), a transmission mode for the cell (e.g., either time division duplex/TDD or frequency division duplex/FDD), acyclic prefix duration for the cell, etc. However, some timing acquisition techniques do not allow for accurate timing acquisition, or may allow for spurious signals to cause errors in timing acquisition.

### SUMMARY

According to an example implementation, a method may of acquiring timing information in a wireless network may include: receiving, by a mobile station from a cell, a first block of symbols and a second block of symbols, each of the first and second blocks of symbols including a plurality of contiguous segments that include a plurality of symbols; performing, by the mobile station, a short correlation of each segment of the first block of symbols with a corresponding segment of the second block of symbols to obtain a plurality of segment correlation results; and determining a block correlation result for the first block of symbols and the second block of symbols based on summing at least a first subset of the segment correlation results and subtracting a second subset of the segment correlation results.

According to another example implementation, an apparatus may include at least one processor and at least one memory including computer instructions, when executed by the at least one processor, cause the apparatus to: receive, by a mobile station from a cell, a first block of symbols and a second block of symbols, each of the first and second blocks of symbols including a plurality of contiguous segments that include a plurality of symbols; perform, by the mobile station, a short correlation of each segment of the first block of symbols with a corresponding segment of the second block of symbols to obtain a plurality of segment correlation results; and determine a block correlation result for the first block of symbols and the second block of symbols based on summing at least a first subset of the segment correlation results and subtracting a second subset of the segment correlation results.

According to another example implementation, a computer program product may include a computer-readable storage medium and storing executable code that, when executed by at least one data processing apparatus, is configured to cause the at least one data processing apparatus to perform a method including: receiving, by a mobile station from a cell, a first block of symbols and a second block of symbols, each of the first and second blocks of symbols including a plurality of contiguous segments that include a plurality of symbols; performing, by the mobile station, a short correlation of each segment of the first block of symbols with a corresponding segment of the second block of symbols to obtain a plurality of segment correlation results; and determining a block correlation result for the first block of symbols and the second block of symbols based on summing at least a first subset of the segment correlation results and subtracting a second subset of the segment correlation results.

According to another example implementation, an apparatus may include means for receiving, by a mobile station from a cell, a first block of symbols and a second block of symbols, each of the first and second blocks of symbols including a plurality of contiguous segments that include a plurality of symbols; means for performing, by the mobile station, a short correlation of each segment of the first block of symbols with a corresponding segment of the second block of symbols to obtain a plurality of segment correlation results; and means for determining a block correlation result for the first block of symbols and the second block of symbols based on summing at least a first subset of the segment correlation results and subtracting a second subset of the segment correlation results.

According to another example implementation, a method may include: receiving, by a mobile station from a cell, a first block of symbols and a second block of symbols, each of the first and second blocks of symbols including a plurality of contiguous segments that include a plurality of symbols; determining, by the mobile station, a set of segment weights including a segment weight associated with each of the segments for the second block of symbols, wherein at least one of the segment weights is different from one or more other segment weights in the set of segment weights; multiplying each of the segment weights by an associated segment of the second block to obtain weighted segments of the second block; performing, by the mobile station, a short correlation of each segment of the first block of symbols with a corresponding weighted segment of the second block of symbols to obtain a plurality of segment correlation results; and determining a block correlation result for the first block of symbols and the second block of symbols based on summing the segment correlation results.

According to another example implementation, an apparatus may include at least one processor and at least one memory including computer instructions, when executed by the at least one processor, cause the apparatus to: receive, by a mobile station from a cell, a first block of symbols and a second block of symbols, each of the first and second blocks of symbols including a plurality of contiguous segments that include a plurality of symbols; determine, by the mobile station, a set of segment weights including a segment weight associated with each of the segments for the second block of symbols, wherein at least one of the segment weights is different from one or more other segment weights in the set of segment weights; multiply each of the segment weights by an associated segment of the second block to obtain weighted segments of the second block; perform, by the mobile station, a short correlation of each segment of the first block of symbols with a corresponding weighted segment of the second block of symbols to obtain a plurality of segment correlation results; and determine a block correlation result for the first block of symbols and the second block of symbols based on summing the segment correlation results.

According to another example implementation, a computer program product may include a computer-readable storage medium and storing executable code that, when executed by at least one data processing apparatus, is configured to cause the at least one data processing apparatus to perform a method including: receiving, by a mobile station from a cell, a first block of symbols and a second block of symbols, each of the first and second blocks of symbols including a plurality of contiguous segments that include a plurality of symbols; determining, by the mobile station, a set of segment weights including a segment weight associated with each of the segments for the second block of symbols, wherein at least one of the segment weights is different from one or more other segment weights in the set of segment weights; multiplying each of the segment weights by an associated segment of the second block to obtain weighted segments of the second block; performing, by the mobile station, a short correlation of each segment of the first block of symbols with a corresponding weighted segment of the second block of symbols to obtain a plurality of segment correlation results; and determining a block correlation result for the first block of symbols and the second block of symbols based on summing the segment correlation results.

According to another example implementation, an apparatus may include means for receiving, by a mobile station from a cell, a first block of symbols and a second block of symbols, each of the first and second blocks of symbols including a plurality of contiguous segments that include a plurality of symbols; means for determining, by the mobile station, a set of segment weights including a segment weight associated with each of the segments for the second block of symbols, wherein at least one of the segment weights is different from one or more other segment weights in the set of segment weights; means for multiplying each of the segment weights by an associated segment of the second block to obtain weighted segments of the second block; means for performing, by the mobile station, a short correlation of each segment of the first block of symbols with a corresponding weighted segment of the second block of symbols to obtain a plurality of segment correlation results; and means for determining a block correlation result for the first block of symbols and the second block of symbols based on summing the segment correlation results.

According to an example implementation a method may include determining a set of a plurality of segment weights, wherein a sum of the segment weights is zero; determining a first block of symbols that includes a plurality of segments; determining a second block of symbols that includes a plurality of segments; determining a weighted second block of symbols by multiplying each segment of the second block of symbols by a corresponding weight of the plurality of segment weights; and, transmitting, by a cell, the first block of symbols and the weighted second block of symbols.

According to another example implementation, an apparatus may include at least one processor and at least one memory including computer instructions, when executed by the at least one processor, cause the apparatus to: determine a set of a plurality of segment weights, wherein a sum of the segment weights is zero; determine a first block of symbols that includes a plurality of segments; determine a second block of symbols that includes a plurality of segments; determine a weighted second block of symbols by multiplying each segment of the second block of symbols by a corresponding weight of the plurality of segment weights; and transmit, by a cell, the first block of symbols and the weighted second block of symbols.

According to another example implementation, a computer program product may include a computer-readable storage medium and storing executable code that, when executed by at least one data processing apparatus, is configured to cause the at least one data processing apparatus to perform a method including: determining a set of a plurality of segment weights, wherein a sum of the segment weights is zero; determining a first block of symbols that includes a plurality of segments; determining a second block of symbols that includes a plurality of segments; determining a weighted second block of symbols by multiplying each segment of the second block of symbols by a corresponding weight of the plurality of segment weights; and transmitting, by a cell, the first block of symbols and the weighted second block of symbols.

According to another example implementation, an apparatus may include means for determining a set of a plurality of segment weights, wherein a sum of the segment weights is zero; means for determining a first block of symbols that includes a plurality of segments; means for determining a second block of symbols that includes a plurality of segments; means for determining a weighted second block of symbols by multiplying each segment of the second block of symbols by a corresponding weight of the plurality of segment weights; and means for transmitting, by a cell, the first block of symbols and the weighted second block of symbols.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram of a wireless transceiver according to an example implementation.

FIG. 3 is a diagram illustrating an example technique that may be used by a MS to perform timing acquisition or synchronization for a cell.

FIG. 4 is diagram illustrating a synchronization metric s(n) using the timing acquisition technique shown by Eqn. (2) and FIG. 3 to acquire timing information or synchronization information.

FIG. 5 is a flow chart illustrating operation of a mobile station according to an example implementation.

FIG. 6 is a flow chart illustrating operation of a mobile station according to an example implementation.

FIG. 7 is a flow chart illustrating operation of a base station/cell according to an example implementation.

FIG. 8 is a diagram illustrating a transmission of a first block of symbols P₁ and a second block of symbols P₂ via each of a plurality of RF beams according to an example implementation.

FIG. 9 is a diagram illustrating a first block of symbols P₁ and a second block of symbols P₂, wherein segments of the second block of symbols are multiplied by alphas or segment weights according to an example implementation.

FIG. 10 is a diagram illustrating a first block of symbols P₁ and a second block of symbols P₂, wherein segments of the second block of symbols are multiplied by alphas or segment weights according to an example implementation.

FIG. 11 is a diagram illustrating the synchronization metric s(n) that may be achieved wherein each block is divided into multiple segments, and segment weights are applied to one of the blocks, according to an example implementation.

FIG. 12 is a block diagram of a wireless station (e.g., base station or mobile station) according to an example implementation.

### DETAILED DESCRIPTION

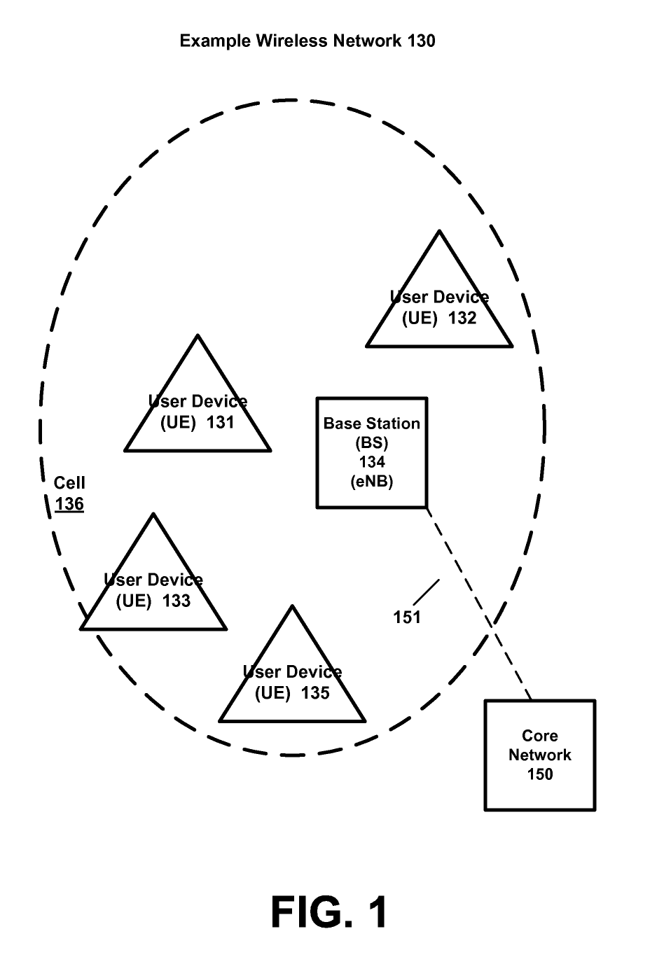

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B (eNB) may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, and/or mmWave band networks, or any other wireless network. LTE, 5G and mmWave band networks are provided only as illustrative examples, and the various example implementations may be applied to any wireless technology/wireless network.

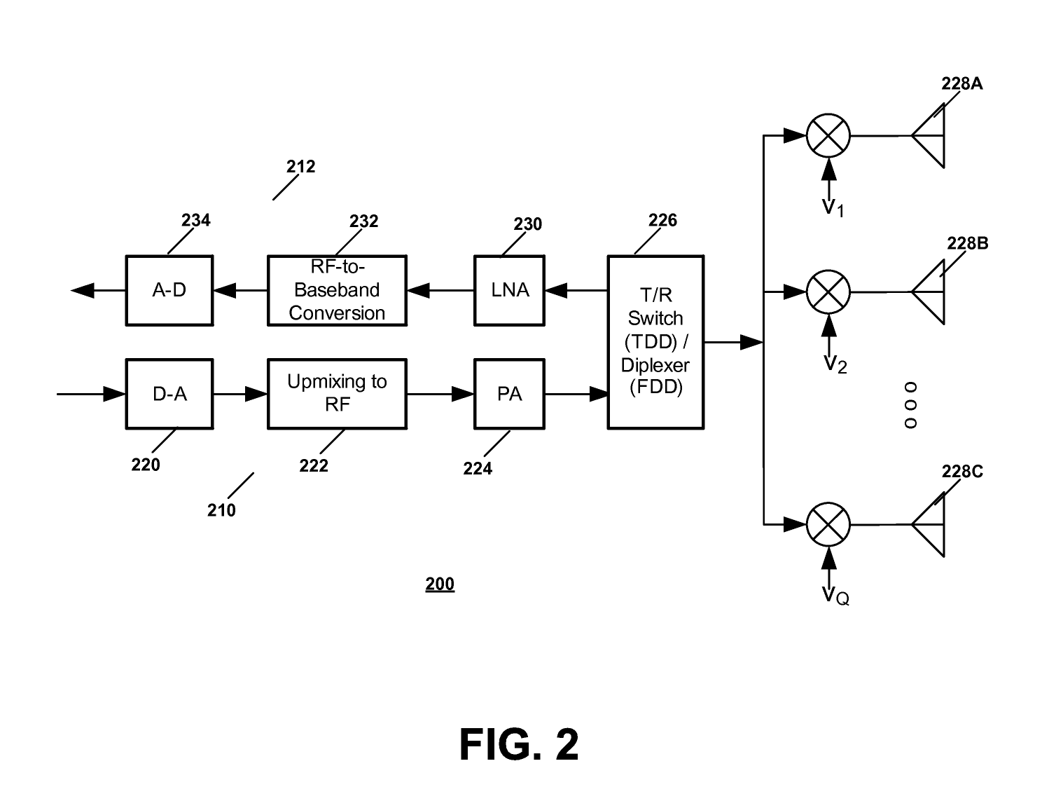

FIG. 2 is a diagram of a wireless transceiver according to an example implementation. Wireless transceiver 200 may be used, for example, at a base station (BS), e.g., Access Point or eNB, or other wireless device. Wireless transceiver 200 may include a transmit path 210 and a receive path 212.

In transmit path 210, a digital-to-analog converter (D-A) 220 may receive a digital signal from one or more applications and convert the digital signal to an analog signal. Upmixing block 222 may up-convert the analog signal to an RF (e.g., radio frequency) signal. Power amplifier (PA) 224 then amplifies the up-converted signal. The amplified signal is then passed through a transmit/receive (T/R) switch (or Diplexer 226 for frequency division duplexing, to change frequencies for transmitting). The signal output from T/R switch 226 is then output to one or more antennas in an array of antennas 228, such as to antenna 228A, 228B and/or 228C. Prior to being transmitted by one or more of the antennas in the array of antennas 228, a set of beam weights V₁, V₂, . . . or V_{Q} is mixed with the signal to apply a gain and phase to the signal for transmission. For example, a gain and phase, V₁, V₂, . . . or V_{Q}, may be applied to the signal output from the T/R switch 226 to scale the signal transmitted by each antenna (e.g., the signal is multiplied by V₁ before being transmitted by antenna 1 228A, the signal is multiplied by V₂ before being transmitted by antenna 2 228B, and so on), where the phase may be used to steer or point a beam transmitted by the overall antenna array, e.g., for directional beam steering. Thus, the beam weights V₁, V₂, . . . or V_{Q} (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam.

In receive path 212 of wireless transceiver 200, a signal is received via an array of antennas 228, and is input to T/R switch 226, and then to low noise amplifier (LNA) 230 to amplify the received signal. The amplified signal output by LNA 230 is then input to a RF-to-baseband conversion block 232 where the amplified RF signal is down-converted to baseband. An analog-to-digital (A-D) converter 234 then converts the analog baseband signal output by conversion block 232 to a digital signal for processing by one or more upper layers/application layers.

One challenge that exists for wireless networks is acquiring timing information or synchronization information from a cell or BS. Initial timing acquisition is a necessary component in wireless communications systems for the receiver (mobile station) to determine a timing reference relative to the transmitter (cell/base station), which may be used by a MS/receiver to identify, e.g., a symbol offset, a frame offset or other timing information with respect to a cell. In some cases, hardware at a receiver may generate, receive or introduce one or more spurious signals (e.g., erroneous or invalid signals that are not the intended data or synchronization signal that the MS is attempting to receive). Other spurious (or unwanted) signals may be received by a MS. A spurious (or unwanted) signal at a MS/receiver may, at least in some cases, cause or introduce errors in the acquisition of synchronization information or timing information with respect to a cell/BS. For example, in some cases, such as, in the case of mmWave (or extremely high frequency), a MS hardware/system may introduce or generate one or more spurious signals when switching from a transmit mode to a receive mode, e.g., see FIG. 2. These spurious signals may, for example, be generated and/or may be received by a MS receiver along with one or more or even all symbols of each of a plurality of blocks of pilot symbols (or block of synchronization symbols) that may be used for acquiring timing or synchronization information. In an illustrative example, spurious (or erroneous) signals that may negatively impact timing or synchronization acquisition by a MS may include, e.g., spurious DC (direct current) signals, a spurious DC offset, spurious decaying DC signals, spurious sinusoidal signals, spurious decaying sinusoids, or other spurious (unwanted) signals.

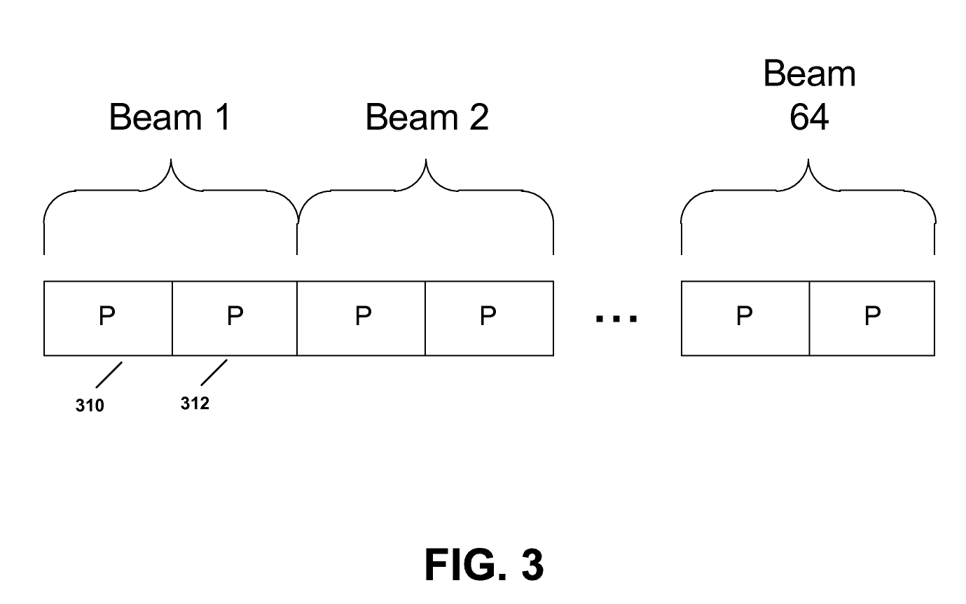

FIG. 3 is a diagram illustrating an example technique that may be used by a MS to perform timing acquisition or synchronization for a cell. The example technique of FIG. 3 may use a repetition of two pilot blocks P (e.g., two blocks where each block is made up of one or more pilot symbols) to perform synchronization. In this example, the transmitting cell/BS may transmit two blocks of pilot symbols (P) for (or via) each of a plurality of RF beams, e.g., for beam 1, beam 2 . . . beam 64, for example. For example a first block of pilot symbols 310 may be transmitted, followed by the transmission of a second block of pilot symbols 312, where the second block of symbols 312 is a repetition or copy of the first block of symbols 310, although there may be, for example, slight variation in amplitude and/or phase of symbols of the two received blocks at the receiver/MS.

As shown in FIG. 3, the receiving MS may receive the blocks of pilot symbols (P) 310, 312 as a received signal y(n), where n indicates the symbol time. The MS may determine a synchronization metric based on the two received blocks of pilot symbols (P) 310, 312. In one example, the MS may determine a synchronization metric s(n) for a cell based on performing a correlation of the first block of symbols 310 with the second block of symbols 312. For example, a synchronization metric that is greater than the threshold or a synchronization metric at a maximum synchronization metric/value may identify timing information and may identify a symbol offset, frame offset or other timing information with respect to a cell.

Therefore, in one example, the synchronization metric s(n) at a given symbol time, n, may be determined based on the correlation of the received signal with a version of itself one symbol block later (e.g., a symbol block may be 512 symbols), generating a correlation result p(n), divided by a power estimate of the signal. In an illustrative example, the MS/receiver may operate at a sample rate of two times the symbol rate. And, y(n) may be the received 2× over-sampled signal, and, it may be assumed that \tilde{y}(n)=y(2n) and only a single receive antenna is present, in this illustrative example. Assuming, for example, a null cyclic prefix single-carrier (NCP-SC) communication system with a block size of 512 symbols and a NCP size of 32 samples (thus, in this example, providing 480 non-zero/data symbols per block P), the synchronization metric (s(n)) for the technique illustrated in FIG. 3 may be determined according to or based upon Eqn. (1):

$$s ( n ) = \frac{{\vert p ( n ) \vert}^{2}}{q ( n ) q ( n - 512 )} , \qquad Eqn . ( 1 )$$

where the correlation result p(n) and power value q(n) may be given by, for example:

$$\begin{matrix}p ( n ) = {\sum }_{𝓁 = 0}^{479} {\tilde{y}}^{*} ( n + 𝓁 ) \tilde{y} ( n + 𝓁 + 512 ) , & Eqn . ( 2 ) \\ q ( n ) = {\sum }_{𝓁 = 0}^{479} {\vert \tilde{y} ( n + 𝓁 + 512 ) \vert}^{2} . & Eqn . ( 3 ) .\end{matrix}$$

The correlation result p(n) may be determined by performing a correlation of the first block of symbols 310 with the second block of symbols 312, across all 480 non-zero/data symbols of each block of symbols, where each block of symbols may include, according to an illustrative example, 480 data or non-zero symbols, 32 symbols of a null cyclic prefix, resulting in 512 total symbols per block, in this illustrative example. In an illustrative example, and as shown by Eqn. (2), correlation of the two blocks of pilot symbols may include, for example, multiplying a complex conjugate (indicated by * sign) of each symbol of the first block of pilot symbols with the corresponding symbol of the second block of pilot symbols to generate 480 symbol products, and then summing the 480 symbol products, to generate the correlation result p(n), for example. Therefore, in one example of the timing acquisition method shown in FIG. 1, a synchronization metric s(n) may be determined as, or at least based upon, the correlation result p(n) for the two blocks of symbols 310, 312, divided by a power estimate for these two received blocks of symbols. For example, the power estimate may be determined as or based upon a product of the power value q(n) of the second block of pilot symbols P multiplied by the power value q(n−512) of the first block of pilot symbols P. Various other techniques may be used to estimate power of the received signal y(n). Also, dividing the squared correlation result p(n) by the power estimate may operate to normalize the synchronization result s(n), or maintain the synchronization result between two numbers, such as between 0 and 1, for example.

However, the timing acquisition technique described by Eqn. (2) and FIG. 3 to acquire timing information or synchronization information for a cell is not robust to various spurious (or unwanted) signals because the correlation result, p(n), may typically be relatively high for these signals. This may occur, at least in some cases, because the spurious signals may be generated/received by the receiver/MS during the same time(s) (or over the time period) that both blocks of pilot symbols 310 and 312 are received. Therefore, a positive correlation result for the spurious signals may typically occur when the MS performs the correlation shown in Eqn. (2). The spurious signals may, for example, include signals such as DC offsets, sinusoidal signals, decaying DC signal, and/or a decaying sinusoid.

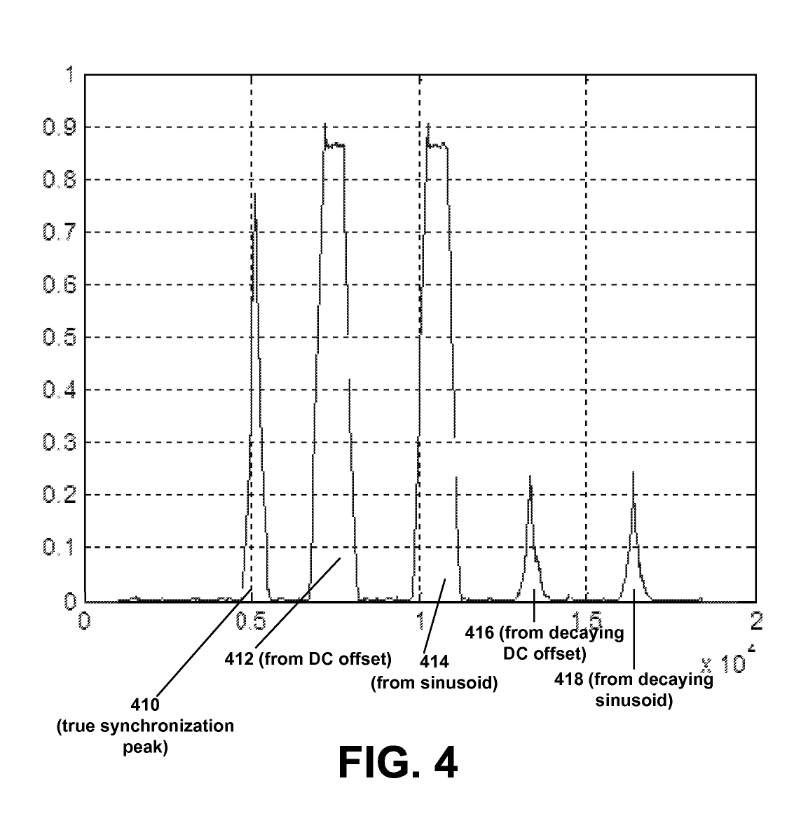

FIG. 4 is diagram illustrating a synchronization metric s(n) using the timing acquisition technique shown by Eqn. (2) and FIG. 3 to acquire timing information or synchronization information. The Y axis of FIG. 4 may be amplitude of the synchronization result (e.g., normalized) and X axis may be time, sample number (for the sampled signal y at the receiver) or symbol number. There are multiple peaks (signal values above a threshold) that contributed to the synchronization metric s(n) shown in FIG. 4, where each peak may be based on a correlation of different signals across the two data blocks P. The peaks shown in FIG. 4 include: the peak 410 which is the true synchronization peak (from the correlation result based on received blocks of pilot symbols P). However, the other peaks in FIG. 4 are example false peaks resulting from the spurious signals (positive correlation peaks based on correlation of spurious signals), including a DC offset peak 412 that is from the correlation of a DC offset, a sinusoid peak 414 that is from correlation of the sinusoid, a peak 416 from a decaying DC offset, and peak 418 from a decaying sinusoid. In fact, peaks 414 and 416 are even greater in amplitude than the true synchronization peak 410 based on correlation of the received blocks of pilot symbols P (310, 312). One or more of the peaks 412, 414, 416 and/or 418 from spurious signals may cause an error in the timing offset (or a false timing detection) that is determined by the MS with respect to a cell.

Therefore, according to an example implementation, a timing acquisition technique is provided that includes one or more technical advantages, such as, for example: 1) providing a timing acquisition that is more robust (or more likely to generate or acquire accurate timing/synchronization) in the presence of spurious signals (e.g., a spurious DC signal, a spurious sinusoidal signal, a spurious decaying DC signal, a spurious decaying sinusoidal signal, a frequency offset); 2) being able to perform timing acquisition for signal-to-noise ratios (SNRs) (e.g., after any beamforming gain) down to around −5.0 dB; 3) perform timing acquisition with multipath channels, phase nose, and operate with multiple RF transmit beams; 4) may provide a synchronization metric or correlation result that may be used with thresholding/comparing to a threshold value, which may speed up average acquisition (e.g., according to an example implementation, acquisition of synchronization or timing is found once a threshold is reached and hence a search for a peak/maximum value over the full time window may not be necessary in this example implementation); 5) provide a metric (e.g., synchronization metric) which operates at the symbol rate and may typically produces a sharp peak where both features improve the accuracy of the initial timing acquisition, for example.

Therefore, according to an example implementation, a timing acquisition technique is provided that, may at least in some ways may be similar to the timing acquisition technique shown by Eqn. (2) and FIG. 3 in that this technique uses correlation based on two received blocks of pilot symbols. However, as noted above, the timing acquisition technique shown by Eqn. (2) and FIG. 3 is not robust with respect to spurious signals due to a positive correlation of such spurious signals.

Therefore, according to an example implementation, a timing acquisition technique is provided that uses two received blocks of pilot symbols, and which operates to at least partially subtract (or at least partially cancel) a correlation result that may be due to a spurious (or unwanted) signal at the receiver, while providing a positive correlation due to symbols of the two blocks of pilot symbols, and thereby improve accuracy of timing acquisition.

According to an illustrative example implementation, at a cell or BS, each of the two blocks of pilot symbols are separated or broken (or segmented or divided) into a plurality of contiguous segments. In an example implementation, initially (before any segment weights are applied), the second block of symbols is the same as (e.g., a copy of) the first block of symbols. This may be done to allow correlation of the two blocks at the receiver to obtain timing/synchronization information. Hence, in an illustrative example, at least initially (before any segment weights are applied to the segments of the second block), each segment of the second block is the same as each corresponding segment of the first block. In an example implementation, a first weight (e.g., a −1) may be multiplied by each of the symbols for a portion, e.g., half, of the segments of one of the two blocks of pilot symbols. For example, a weight of −1 may be multiplied by half the segments of the second block (although it could be first block of symbols in another example). The cell then transmits the two blocks of pilot symbols where each block of pilot symbols includes a plurality of segments. As noted, a subset or portion (e.g., half), of the segments of one of the blocks is first multiplied by a negative weight, such as a −1, before transmitting/broadcasting such segments.

According to an example implementation, at the MS, the two blocks of pilot symbols are received. A short correlation is performed for each segment of the first block against a corresponding segment of the second block to obtain a plurality of segment correlation results. A block correlation result may be obtained based on summing at least a first subset of the segment correlation results and subtracting a second subset of the segment correlation results. For example, to determine a block correlation result (based on the first and second blocks of pilot symbols), half of the segment correlation results may be added while half of the segment correlation results may be subtracted, e.g., with the half of the segment correlation results that are subtracted corresponding to the segments of one of the blocks having a negative weight (e.g., −1) applied or multiplied by such symbols or segments before transmission.

According to an example implementation, adding half of the segment correlation results while subtracting the other half of the segment correlation results at the MS may at least partially cancel out the correlation results (or contribution to the correlation results) due to a spurious signal(s) which may be received or detected by the MS in both blocks of symbols. However, applying (or multiplying) a negative one or negative weight (e.g., −1) to half of the segments of one of the blocks at the BS before transmission, and then subtracting half of the segment correlation results at the MS (corresponding to the negative segments transmitted by the BS) may result in a positive correlation result for the two blocks of data symbols, while (at least partially) subtracting correlation results due to the spurious signal(s).

Alternatively, if half the segments of a second block were multiplied by a weight of −1, then the MS may multiply these same weighted segments of the second block by a −1, and the perform the short correlation between each segment of the first block and each corresponding segment of the second block to determine segment correlation result for each of a plurality of segments. These segment correlation results may be added to obtain the block correlation result. The use of the weight of −1 (in this illustrative example) at the transmitter and at the receiver may operate to subtract cancel a spurious or unwanted signal at the receiver, while providing a positive correlation of the desired blocks of symbols, which may improve accuracy of the receiver's acquisition of timing/synchronization information. Multiplying the weight (e.g., −1 in this example) at the MS/receiver by each segment that was weighted before performing short correlation, may be considered to be the same (e.g., mathematically the same) as multiplying such weight (e.g., −1) by the associated segment correlation results.

Thus, according to an example implementation, one example technique of dividing each block of symbols into multiple segments, multiplying a weight (e.g., −1) by at least some of the segments, performing short correlations for corresponding segments of the first and second blocks to determine segment correlation results, and the adding the segment correlation results to obtain a block correlation result that may provide timing/synchronization information or may be used to determine timing/synchronization information. This example technique may be generalized to include any number of segments for each block, e.g., 2 segments, 4 segments, 8 segments, . . . , and may be generalized where any segment weight a (e.g., where a segment weight a may include an amplitude and phase) may be multiplied by each segment of one of the blocks. For example, if there are four segments (e.g., segment 1, segment 2, segment 3 and segment 4) for each of the first block and the second block, and a set of four segment weights may be multiplied by the (the symbols of) each of the four segments of the second block (for example), as follows: Weighted block 2 may include the following weighted segments: α₁×(symbols of) segment 1 (of block 2), α₂×segment 2 (of block 2), α₃×segment 3 (of block 2), α₄×segment 4 (of block 2). The first block of segments and the weighted second block of segments may then be transmitted to the MS. For example, in an example implementation, the segment weights a for the second block of symbols may or should add up to zero, to provide a substantial cancelling effect for any spurious or unwanted signals generated by the MS or receiver, as described in greater detail hereinbelow. Each segment weight may have an amplitude and phase. For example, the following segment weights may be used: α₁=1 (amplitude of 1, with a phase of 0); α₂=j (e.g., amplitude of 1 with a phase of 90°); α₃=−1 (amplitude of 1, with a phase of 180°); and, α₄=−j (amplitude of 1, with a phase of −90°). These set of segment weights (e.g., 1, j, −1, −j) add up to zero.

The receiver or MS may receive the first block of symbols, and then may receive the weighted second block of symbols. The MS may use two alternative techniques, which may be considered the same (e.g., mathematically the same, or achieving the same result or output of segmentation correlation results at the MS). 1) multiplying each weighted segment of the second block by a complex conjugate of the segment weight for that segment, and then performing short correlations for each segment of the first block with a corresponding (complex conjugate weighted) weighted segments of the second block to determine a set of segment weights; or, 2) performing short correlations for each segment of the first block with a corresponding weighted segment of the second block to obtain a first set of segment correlation results, and then multiply each of the segment correlation results of the first set of segment correlation results by a corresponding complex conjugate weight to obtain a set of segment correlation results. Thus, in example technique 1) the complex conjugate weight for each of the segments of the second block is first multiplied by the segments of the second block before performing the short correlations to obtain a set of segment correlation results; while in the example technique 2) the complex conjugate segment weights are multiplied by corresponding short correlation outputs to obtain a set of segment correlation results. Both of these techniques may be considered mathematically the same or substantially the same, since the order of the multiplication of the complex conjugate weights may be changed, while still obtaining the same segment correlation results.

The MS may determine the complex conjugate of each of the weights that BS/cell multiplied by the segments of the second block. For example, the complex conjugate of α₁=1, may be α₁*=1, where the * means complex conjugate. Therefore, the complex conjugate segment weights α₁*, α₂*, α₃*, α₄* may be determined as (based on the above illustrated example):
α₁=1; thus, α₁*=1;
α₂=j; thus, α₂*=−j;
α₃=−1; thus, α₃*=−1;
α₄=−j; thus, α₄*=j.

According to an example implementation, the segment weights a for the second block (or for one of the blocks) of symbols may or should add up or sum to zero. And, the complex conjugates of the segment weights for the second block (or for one of the blocks) should also add up or sum to zero. For example, the set of segment weights (e.g., 1, j, −1, −j) add up to zero. Similarly, the complex conjugate segment weights (e.g., 1, −j, −1, j) also add up to zero. In fact, by providing a set of segment weights that add or sum to zero, the set of complex conjugate weights would also sum to zero. While the segment weights and complex conjugate segment weights shown in these examples have an amplitude of 1, any amplitude may be used for the segment weights, e.g., amplitude of 1.2, 1.5, 2.0, 2.5, 3.0, etc. It would still be preferred, however, that the set of segments weights would still sum to zero even with amplitudes different than 1. The only change that would be needed to accommodate segment weights with amplitudes different than 1 would be to replace the multiplication with the complex conjugation with either the segments (for example technique 1) above) or with the corresponding short correlation outputs (for example technique 2) above) with a division by the corresponding segment weight.

According to an example implementation, using a set of complex conjugate weights by the receiver/MS that add or sum to zero provides a cancelling effect for any spurious or unwanted signals generated by (or occurring at) the MS or receiver. In one illustrative example, with the segment weights and thus, the complex conjugate segment weights, of one of the blocks (e.g., the second block) adding up to zero, this may cause a spurious signal to be added via some of the segment correlations, and may cause the spurious signal to be at least partially subtracted via others of the segment correlations in a manner that may (at least partially) cancel or subtract the spurious or unwanted signal at the receiver. More generally, with the complex conjugate segment weights of one of the blocks adding up to zero, this may cause the spurious or unwanted signal (not the blocks of pilot symbols) to be added out-of-phase (or incoherently), which may cancel all or part of the unwanted/spurious signal(s) at the receiver, for example. While using the segment weights at the transmitter (prior to transmission) for one of the blocks (e.g., the second block) of symbols, and then using (multiplying) the complex conjugate weights by the received set of segments for the same block (e.g., the second block) at the receiver/MS, this may allow a positive (or in-phase) correlation to be provided for the corresponding segments of the two blocks of pilot symbols, and thereby provide more accurate acquisition of timing/synchronization information.

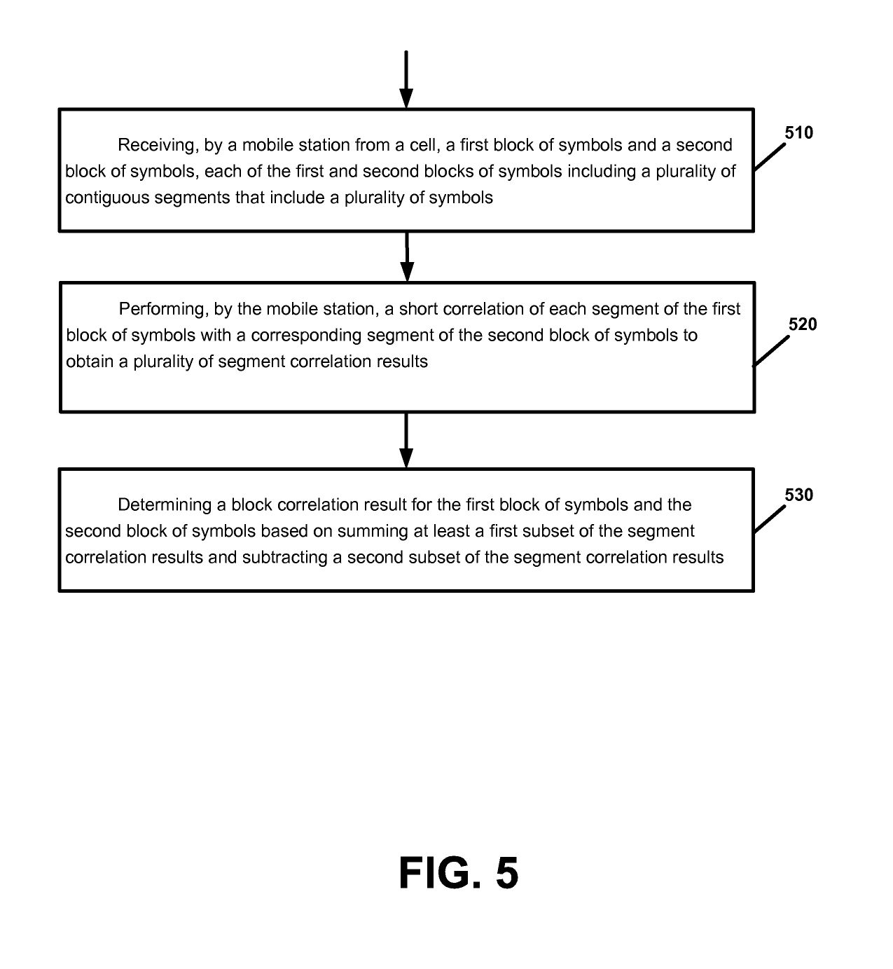

FIG. 5 is a flow chart illustrating operation of a mobile station according to an example implementation. The flow chart of FIG. 5 may describe a method of acquiring timing information in a wireless network. Operation 510 includes receiving, by a mobile station from a cell, a first block of symbols and a second block of symbols, each of the first and second blocks of symbols including a plurality of contiguous segments that include a plurality of symbols. Operation 520 includes performing, by the mobile station, a short correlation of each segment of the first block of symbols with a corresponding segment of the second block of symbols to obtain a plurality of segment correlation results. Operation 530 includes determining a block correlation result for the first block of symbols and the second block of symbols based on summing at least a first subset of the segment correlation results and subtracting a second subset of the segment correlation results.

According to an example implementation, the method of FIG. 5 may further include determining a synchronization metric based on the block correlation result; and receiving, by the mobile station, data from the cell based on the synchronization metric.

According to an example implementation of the method of FIG. 5, the determining a block correlation result for the first block of symbols and the second block of symbols based on summing at least a first subset of the segment correlation results and subtracting a second subset of the segment correlation results at least reduces a contribution to the block correlation result from one or more spurious signals received by or generated by the mobile station.

According to an example implementation of the method of FIG. 5, the method may further include at least reducing, by the mobile station, an erroneous contribution of a spurious signal to the block correlation result by at least partially cancelling the spurious signal by summing the spurious signal via summing the first subset of the segment correlation results and subtracting the spurious signal via subtracting the second subset of the segment correlation results.

According to an example implementation of the method of FIG. 5, the determining a block correlation result may include: determining a block correlation result for the first block of symbols and the second block of symbols based on summing a first half of the segment correlation results and subtracting a second half of the segment correlation results, wherein the subtracting the second half of the segment correlation results is performed for segments of one of the blocks that were multiplied by a negative weight before transmission.

According to an example implementation of the method of FIG. 5, the determining a synchronization metric based on the block correlation result may include determining a synchronization metric as the block correlation result divided by a power value.

According to an example implementation of the method of FIG. 5, the method may further include limiting a minimum value of the power value.

According to an example implementation of the method of FIG. 5, the method may further include setting the synchronization metric to zero if the power value is less than a threshold.

According to an example implementation of the method of FIG. 5, the determining a synchronization metric based on the block correlation result may include: determining a synchronization metric as the block correlation result divided by a maximum power value for the received blocks of symbols.

According to an example implementation of the method of FIG. 5, the synchronization metric identifies symbol timing or frame timing at a peak or maximum value of the synchronization metric.

According to an example implementation of the method of FIG. 5, the receiving may include receiving, by a mobile station from a cell via each of a plurality of radio frequency (RF) beams, a first block of symbols and a second block of symbols, each of the first and second blocks of symbols including a plurality of contiguous segments that include a plurality of symbols; wherein the performing, determining a block correlation result, and determining a synchronization metric is performed for each of the plurality of RF beams.

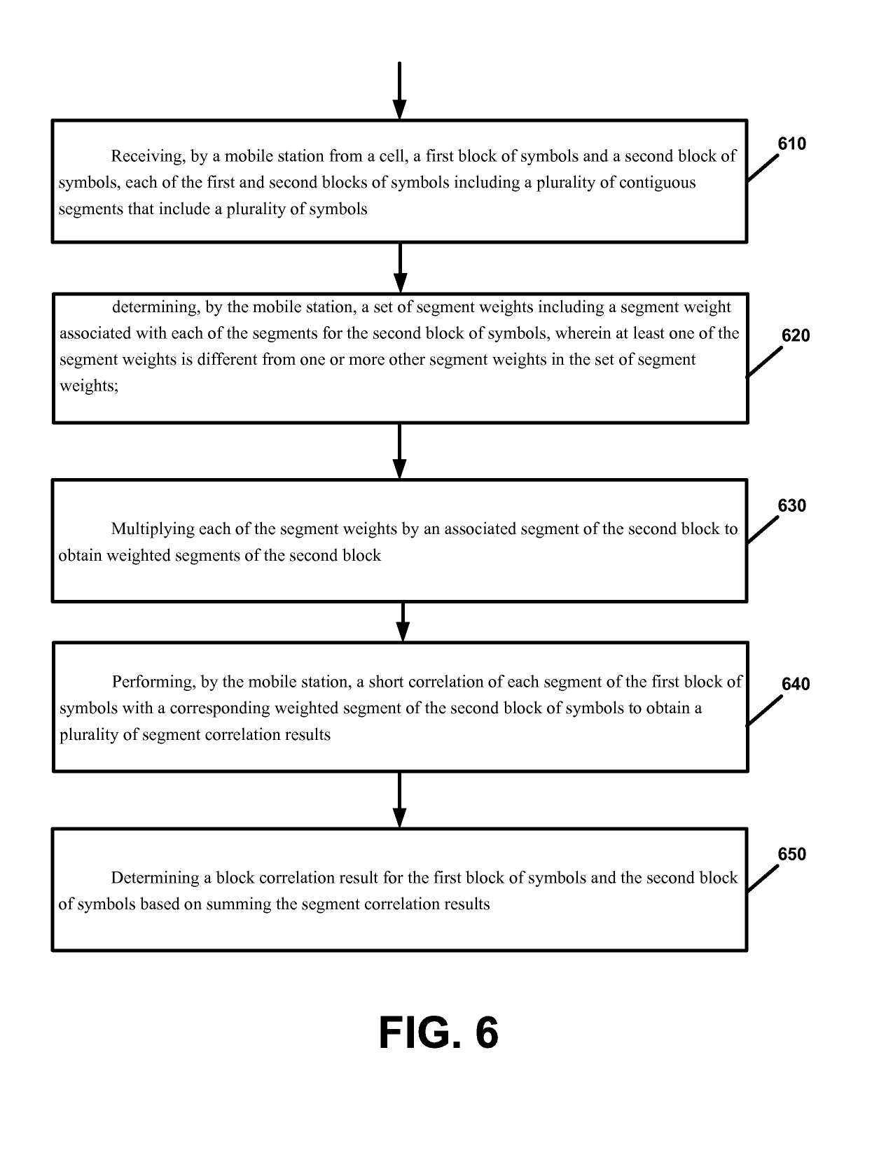

FIG. 6 is a flow chart illustrating operation of a mobile station according to another example implementation. The method of FIG. 6 may relate to acquiring timing information in a wireless network. Operation 610 may include receiving, by a mobile station from a cell, a first block of symbols and a second block of symbols, each of the first and second blocks of symbols including a plurality of contiguous segments that include a plurality of symbols. Operation 620 may include determining, by the mobile station, a set of segment weights including a segment weight associated with each of the segments for the second block of symbols, wherein at least one of the segment weights is different from one or more other segment weights in the set of segment weights. Operation 630 may include multiplying each of the segment weights by an associated segment of the second block to obtain weighted segments of the second block. Operation 640 may include performing, by the mobile station, a short correlation of each segment of the first block of symbols with a corresponding weighted segment of the second block of symbols to obtain a plurality of segment correlation results. And, operation 650 may include determining a block correlation result for the first block of symbols and the second block of symbols based on summing the segment correlation results.

According to an example implementation of the method of FIG. 6, the method may further include determining a synchronization metric based on the block correlation result; and receiving, by the mobile station, data from the cell based on the synchronization metric.

According to an example implementation of the method of FIG. 6, the first block of symbols and the second block of symbols are received by the mobile station in a time order according to one of the following: the first block of symbols is received first in time and the second block of symbols is received second; and the second block of symbols is received first and the first block of symbols is received second.

According to an example implementation of the method of FIG. 6, the determining, by the mobile station, a set of segment weights comprises determining a segment weight associated with each of the segments for the second block of symbols, wherein a sum of the set of segment weights is zero.

According to an example implementation of the method of FIG. 6, the second block of symbols are provided by a cell as an initial second block of symbols multiplied by a first set of segment weights to provide the second block of symbols received by the mobile station, and wherein the determining, by the mobile station, a set of segment weights comprises determining a second set of segment weights associated with each of the segments for the second block of symbols, wherein each segment weight of the second set of segment weights is a complex conjugate of a corresponding segment weight of the first set of segment weights.

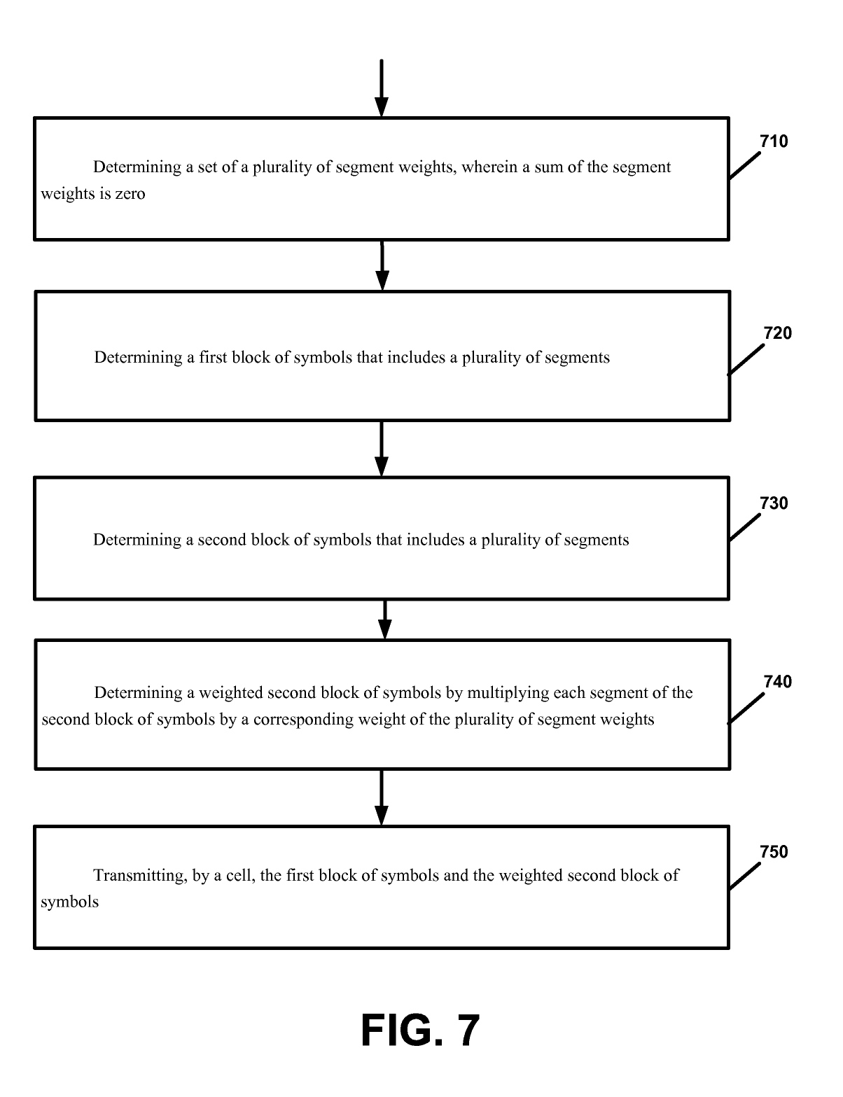

FIG. 7 is a flow chart illustrating operation of a base station or cell according to an example implementation. Operation 710 may include determining a set of a plurality of segment weights, wherein a sum of the segment weights is zero. Operation 720 may include determining a first block of symbols that includes a plurality of segments. Operation 730 may include determining a second block of symbols that includes a plurality of segments. Operation 740 may include determining a weighted second block of symbols by multiplying each segment of the second block of symbols by a corresponding weight of the plurality of segment weights. And, operation 750 may include transmitting, by a cell, the first block of symbols and the weighted second block of symbols.

According to an example implementation of the method of FIG. 7, the method may further include transmitting information that indicates the set of segment weights.

According to an example implementation of the method of FIG. 7, a first half of the segment weights are a positive value, and a second half of the segment weights are a negative value. According to an example implementation of the method of FIG. 7, the first half of the segment weights are a positive 1 (+1), and a second half of the segment weights are a negative one (−1).

According to an example implementation of the method of FIG. 7, the transmitting may include transmitting, by a cell, the first block of symbols and the weighted second block of symbols via each of a plurality of radio frequency (RF) beams.

Further details related to other example implementations will now be described.

One problem or disadvantage with the timing acquisition technique of Eqn. (2) and FIG. 3 is that such technique does not exploit the structure of the pilots and hence when computing p(n) in Eqn. (2), a (an unwanted or spurious) DC signal or a sinusoidal signal may typically produce a large correlation and hence may typically cause an erroneous correlation result or contribution, which may cause an error in timing/synchronization acquisition. However if, for example, the second block of pilot symbols were to be broken into two equal-sized segments, where the first segment of the second pilot block is the same as the first segment of the first pilot block but the second segment of the second pilot block is the negative of the first segment of the first block, then these spurious DC and sinusoidal signals would have decreased correlation result due to a (at least partially) cancelling of the correlation results of such spurious signals. Thus, based on the use of a negative sign or weight for half (or a portion) of the segments of the second block, the segment correlation results due to the spurious signal(s) may add or sum out of phase or incoherently, for example.

In an example implementation, each block of symbols may be divided into two segments (for example), and a segment weight a may be determined for each segment of one of the blocks, e.g., for the second blocks of symbols. α₁, α₂ may be the segment weights for the first and second segments of the second block, in an illustrative example. For example for the NCP-SC system with a block size of 512 symbols and a NCP size of 32 symbols, when breaking up the pilots into the two segments just mentioned, the p(n) calculation changes to:

$$p ( n ) = {α}_{1}^{*} {\sum }_{𝓁 = 0}^{239} {\tilde{y}}^{*} ( n + 𝓁 ) \tilde{y} ( n + 𝓁 + 512 ) + {α}_{2}^{*} {\sum }_{𝓁 = 240}^{479} {\tilde{y}}^{*} ( n + 𝓁 ) \tilde{y} ( n + 𝓁 + 512 ) . \qquad Eqn . ( 4 a )$$

Which for α₁=+1 and α₂=−1 in the above example, p(n) becomes:

$$p ( n ) = {\sum }_{𝓁 = 0}^{239} {\tilde{y}}^{*} ( n + 𝓁 ) \tilde{y} ( n + 𝓁 + 512 ) - {\sum }_{𝓁 = 240}^{479} {\tilde{y}}^{*} ( n + 𝓁 ) \tilde{y} ( n + 𝓁 + 512 ) \qquad Eqn . ( 4 b )$$

Note that because of the negation (due to α₂=−1) on the second summation (second short correlation) term in Eqn. (4b), a DC signal and a sinusoidal signal (unwanted/spurious signals at the receiver) will now be cancelled or reduced when p(n) is calculated and such spurious signals will not typically produce a large peak, for example. This (at least partial) cancellation is because the second summation/second short correlation (ignoring the negative symbol) will be approximately be the same as the first summation thus producing a very low output.

Breaking up the second (for example) block of pilot symbols (which may simply be referred to as the second block of symbols or just the second block) into two segments ends up reducing the peak produced by a spurious DC signal or a sinusoidal signal by ¼. The ¼ is due to the fact that only the main peak caused by a DC signal is cancelled but not the peaks caused by a finite duration DC signal from the first or second summation (i.e., when the DC signal is present in the first or last 240 symbols but not the entire 480 symbols used to compute the summations/correlations in Eqn. (4b)). The first and second summations in Eqn. (4) contain only half of the DC samples and because of the squaring operation in Eqn. (1) will produce a value of ¼ of the DC power. Thus, the ¼ would limit the threshold that could be used (e.g., to detect synchronization) to 0.25 thus causing a loss of synchronization performance at the lower SNRs (signal to noise ratios).

Therefore, to reduce the threshold, (e.g., down to approximately 0.04 (in an illustrative example, which enables detection down to −5 dB), then each the blocks of pilot symbols may need to be divided (or segmented) into, for example, 8 segments with some combination of negations (e.g., in one example, negative weights may be applied to some of the segments of one of the blocks to provide a cancellation effect). Note, for example, that dividing each block into 8 segments may reduce a synchronization metric s(n) for such spurious DC signal down to (⅛)²=0.015625 which is less than a 0.04 threshold required to provide synchronization detection at around −5.0 dB, for example.

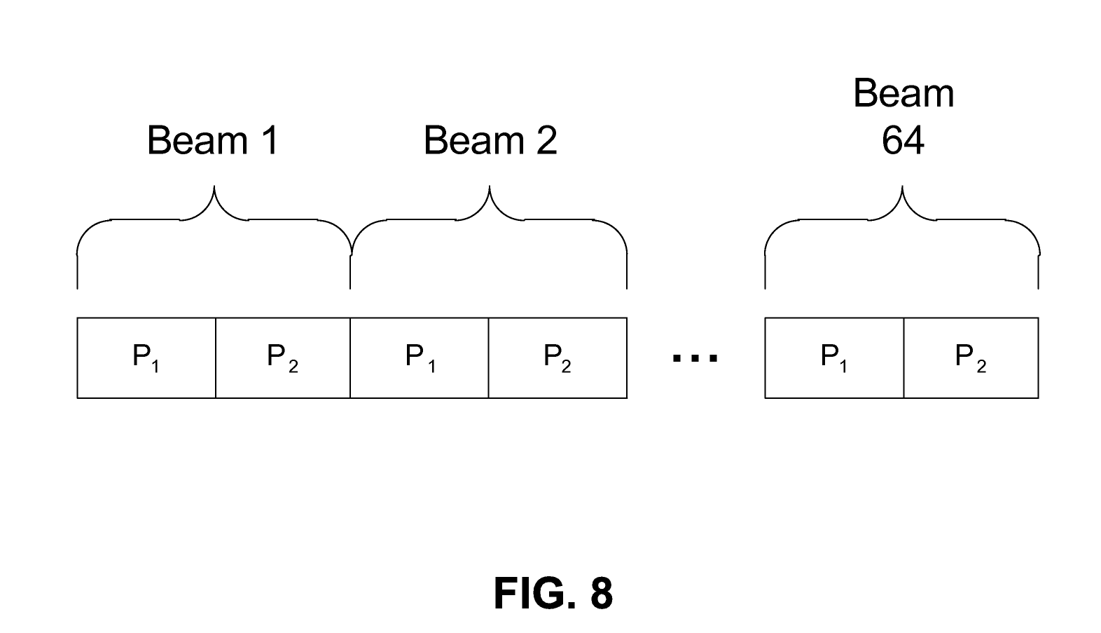

FIG. 8 is a diagram illustrating a transmission of a first block of symbols P₁ and a second block of symbols P₂ via each of a plurality of RF beams according to an example implementation. In the example shown in FIG. 8, each of the two blocks are transmitted via each of the 64 RF beams to the MS. As noted, the first and second blocks may initially be the same (copies), and then segment weights (or alphas) may be applied (or multiplied by) the segments of one of the blocks, e.g., the second block. Hence, according to an illustrative example implementation, an initial timing acquisition signal may created by transmitting two pilot blocks, P₁ and P₂, which are related to each other, and are sent in adjacent NCP-SC blocks on each of the RF beams as shown in FIG. 8. In this illustrative example shown in FIG. 8, P₁ is broken up into 8 segments (P_{1,1} through P_{1,8}) and P₂ is made up of the same segments in the same order but with each segment being multiplied by segment weights or alphas, either +1 or −1 (as an example).

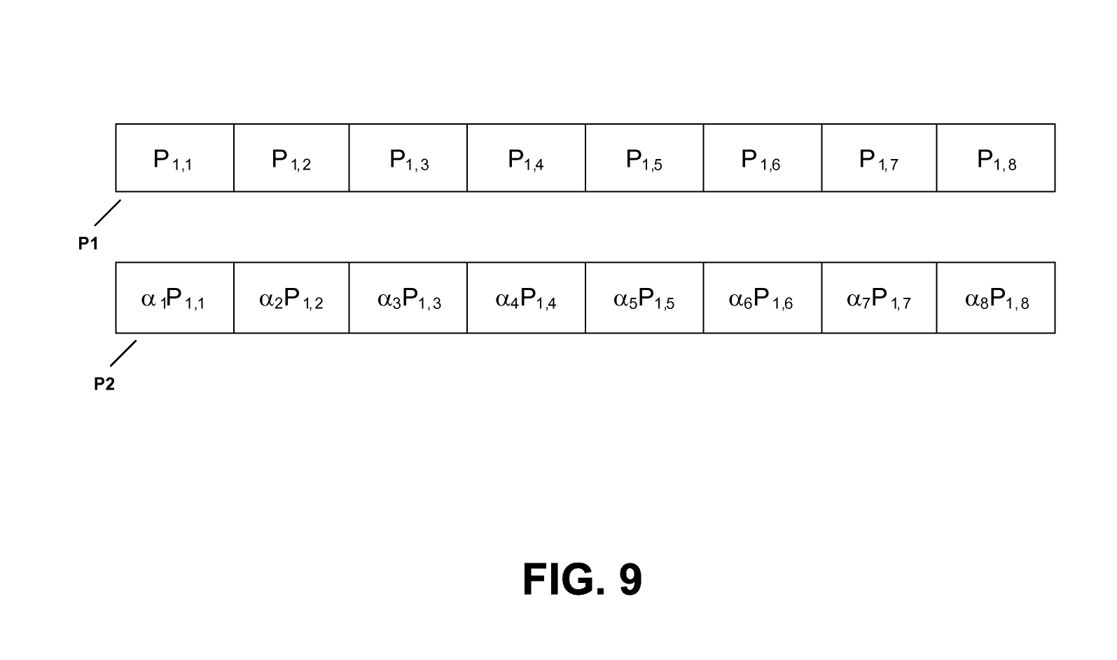

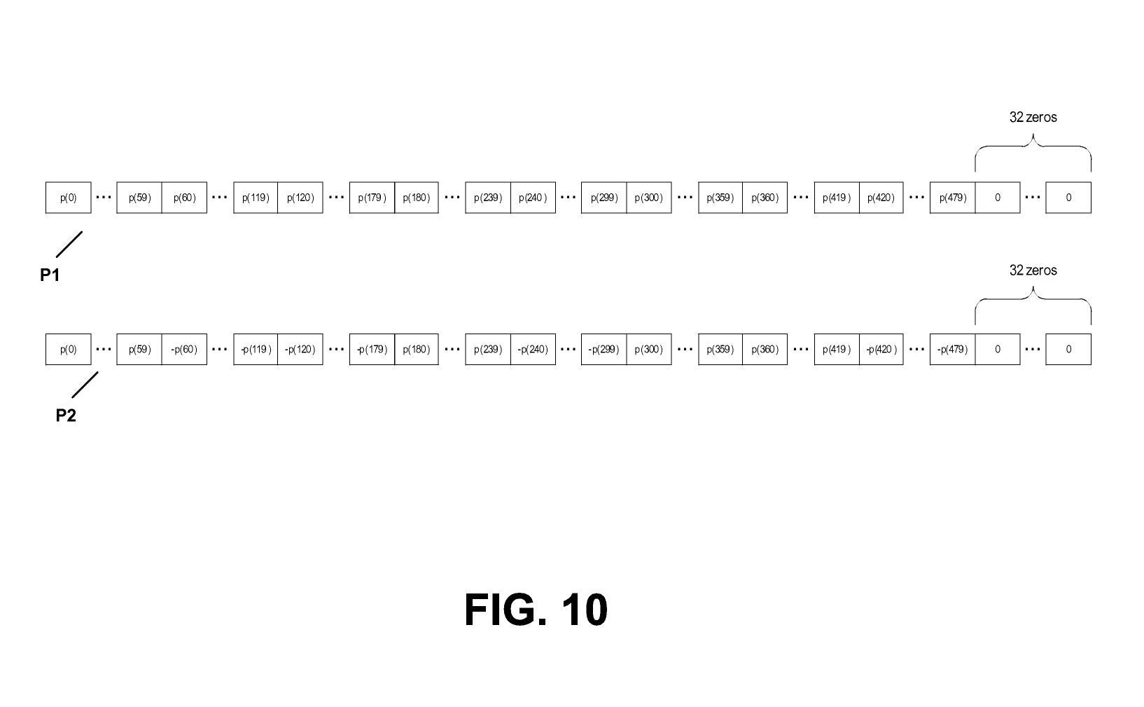

This idea is shown in FIG. 9 where the multiplication by +1 or −1 is captured by the segment weights α₁ through α₈. FIG. 10 is a diagram illustrating a first block of symbols P₁ and a second block of symbols P₂, wherein segments of the second block of symbols are multiplied by alphas or segment weights according to an example implementation. A good choice of alphas may be, for example, [+1, −1, −1, +1, −1, +1, +1, −1] which was found by first breaking P₁ into two segments with alphas of [+1, −1]. Next the two segments are broken into two segments each with alphas of [+1, −1] within each segment giving a final set of alphas of [+1, −1, −1, +1]. Next each of these four segments are broken into two segments each with alphas of [+1, −1] within each segment giving the final set of alphas of [+1, −1, −1, +1, −1, +1, +1, −1]. An example of this segmentation with this set of alphas is shown in FIG. 9 for the example NCP-SC system with a block size of 512 and a NCP size of 32. In the illustrative example shown in FIG. 10, each segment (8 segments of non-zero symbols for each block) shown is 60 symbols long. Other choices of alphas are possible such as [+1, −1, +1, −1, +1, −1, +1, −1] but at least in simulations it appears not to produce as good of a final metric as the previous set of alphas. Also using [+1, −1, +1, −1, +1, −1, +1, −1] may not produce the desired cancelling effect for certain sinusoidal frequencies. The main design paradigm of the alphas is to have the sum of the alphas be zero but also give the sharpest peak in the metric for the most accurate timing estimate.

According to an example implementation, the metric will be written relative to a NCP-SC system whose receiver may operates at a sample rate of two times the symbol rate with a block size of N symbols and NCP length of L_{CP}. Letting N_{D}=N−L_{CP} (N_{D} is the number of non-zero symbols in a block) and y(n) be the received 2× over-sampled signal and assume that \tilde{y}(n)=y(2n) and only a single receive antenna is present. If two receivers are present (e.g., for two-stream MIMO operation) both p(n) and q(n) below would simply be replaced with the sum of the p(n) and q(n) found separately on the two receive chains. Assuming that the pilots are broken into 8 segments and letting Nₛ=N_{D}/8 be the length of a segment, the synchronization metric used is a modified version of (1) and is given by:

$$s ( n ) = \frac{{\vert p ( n ) \vert}^{2}}{max \{ {q}^{2} ( n ) , {q}^{2} ( n - N ) \}} , \qquad Eqn . ( 5 )$$

Where p(n) and q(n) are now given by:

$$\begin{matrix}p ( n ) = {\sum }_{m = 1}^{8} {α}_{m}^{*} {\sum }_{𝓁 = {N}_{s} ( m - 1 )}^{{N}_{s} m - 1} {\tilde{y}}^{*} ( n + 𝓁 ) \tilde{y} ( n + 𝓁 + N ) = {\sum }_{m = 1}^{8} {α}_{m}^{*} d ( n + {N}_{s} ( m - 1 ) ) , & Eqn . ( 6 ) \\ q ( n ) = {\sum }_{𝓁 = 0}^{{N}_{D}} {\vert \tilde{y} ( n + 𝓁 + N ) \vert}^{2} , & Eqn . ( 7 )\end{matrix}$$

where d(n) is given as:

$$d ( n ) = {\sum }_{𝓁 = 0}^{{N}_{S}} {\tilde{y}}^{*} ( n + 𝓁 ) \tilde{y} ( n + 𝓁 + N ) . \qquad Eqn . ( 8 )$$

Note that the expression for d(n) is an example of a short correlation. Also, each of the eight summations shown in Eqn. (6) are also examples of a short correlation. Note that, according to an example implementation, the max term may be added to (or used within) the denominator of Eqn. (5) to help improve the metric for decaying signals or signals with increasing power which might trip up the synchronization (i.e., now the larger of the power of the first and second blocks is used thus decreasing the metric in this case).

As is the case of the metric in Eqn. (1), there is a simple update formula at each sample point for the metric which, for q(n), is:

q(n)=q(n−1)+b(n)−b(n−N), with Eqn. (9)

b(n)=|\tilde{y}(n−1+N+N_{D}|². Eqn. (10)

The update formula for d(n) is:

d(n)=d(n−1)+a(n+Nₛ)−a(n), Eqn. (11),

a(n)=\tilde{y}*(n−1)\tilde{y}(n−1+N). Eqn. (12)

Finally, p(n) may be given as:

$$p ( n ) = {\sum }_{m = 1}^{8} {α}_{m}^{*} d ( n + {N}_{s} ( m - 1 ) ) , \qquad Eqn . ( 13 )$$

So, in order to determine an updated p(n) for a new symbol, at each symbol time, n, only the multiplications in Eqns. (10) and (12) and the multiplications and division of Eqn. (5) needs to be performed and the rest of the calculation is all additions and subtractions.

According to another example implementation, the denominator of Eqn. (5) may be limited in an actual implementation to some value set by the hardware so that a division by zero or a very low value is avoided. Another option in this case is to just output s(n)=0 when the denominator is below some value as determined by the hardware or software. In other words if the signal power is very low, assume that the acquisition signal is not present and synchronization is not detected, for example.

Another aspect may include the use of different sets of alphas for transmission of the two blocks of symbols over each beam where the different alphas could contain information such as the beam number (e.g., use different sets of alphas/segment weights for each RF beam).

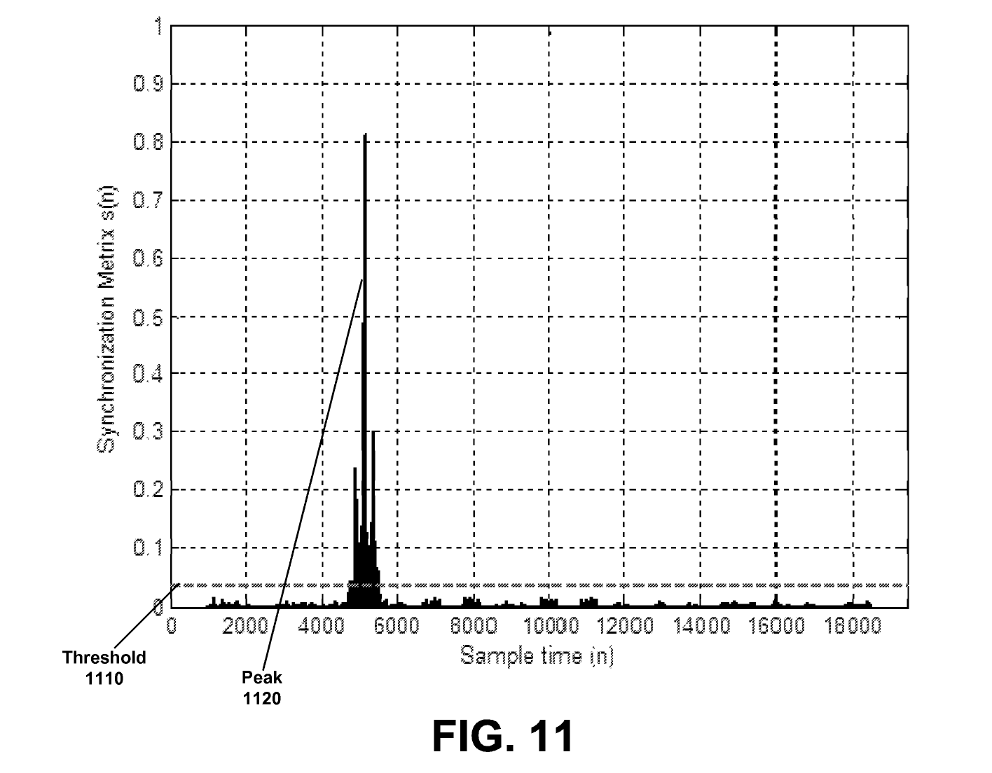

FIG. 11 is a diagram illustrating the synchronization metric s(n) that includes a sharp peak 1120 due to the correlation of the pilot symbols that is significantly greater than any peaks or signals caused by any spurious signals when each block was divided into 8 segments. A threshold of 0.04 is shown at 1110, for determining detection. Thus, it can be seen that acquisition of timing information can be significantly improved, even with spurious DC offsets and spurious sinusoids that are 10 dB stronger than the synchronization signal. Thus, when applying the techniques above to divide each block into multiple segments, and apply segment weights to one of the blocks, and then apply complex conjugate weights at the MS/receiver, the accuracy or performance of timing acquisition may be significantly improved. For example, for comparison, performance of FIG. 11 is superior (where no other signals are even close to the peak from the blocks of symbols for timing acquisition), as compared to FIG. 4 (where several peaks are shown from spurious signals that are greater than the peak from the blocks of symbols).

For example, to perform this simulation, according to an illustrative example, a NCP-SC system may be simulated with a block size of N=512, a NCP length of 32, a data portion of N_{D}=480, a root-raised cosine pulse with a beta value of 0.3, a symbol rate of 0.75 GHz, and a carrier frequency of 72 GHz. The system has 64 RF beams and acquisition is achieved if at least one of the beams is detected. An AWGN channel is simulated for each beam where the channel is normalized to unit power for the strongest beam (hence SNR is relative to the strongest beam). For these example, simulations a 1.0 MHz frequency offset was present.

According to another example implementation, an apparatus may include at least one processor and at least one memory including computer instructions, when executed by the at least one processor, cause the apparatus to: receive, by a mobile station from a cell, a first block of symbols and a second block of symbols, each of the first and second blocks of symbols including a plurality of contiguous segments that include a plurality of symbols; perform, by the mobile station, a short correlation of each segment of the first block of symbols with a corresponding segment of the second block of symbols to obtain a plurality of segment correlation results; and determine a block correlation result for the first block of symbols and the second block of symbols based on summing at least a first subset of the segment correlation results and subtracting a second subset of the segment correlation results.

According to another example implementation, a computer program product may include a computer-readable storage medium and storing executable code that, when executed by at least one data processing apparatus, is configured to cause the at least one data processing apparatus to perform a method including: receiving, by a mobile station from a cell, a first block of symbols and a second block of symbols, each of the first and second blocks of symbols including a plurality of contiguous segments that include a plurality of symbols; performing, by the mobile station, a short correlation of each segment of the first block of symbols with a corresponding segment of the second block of symbols to obtain a plurality of segment correlation results; and determining a block correlation result for the first block of symbols and the second block of symbols based on summing at least a first subset of the segment correlation results and subtracting a second subset of the segment correlation results.

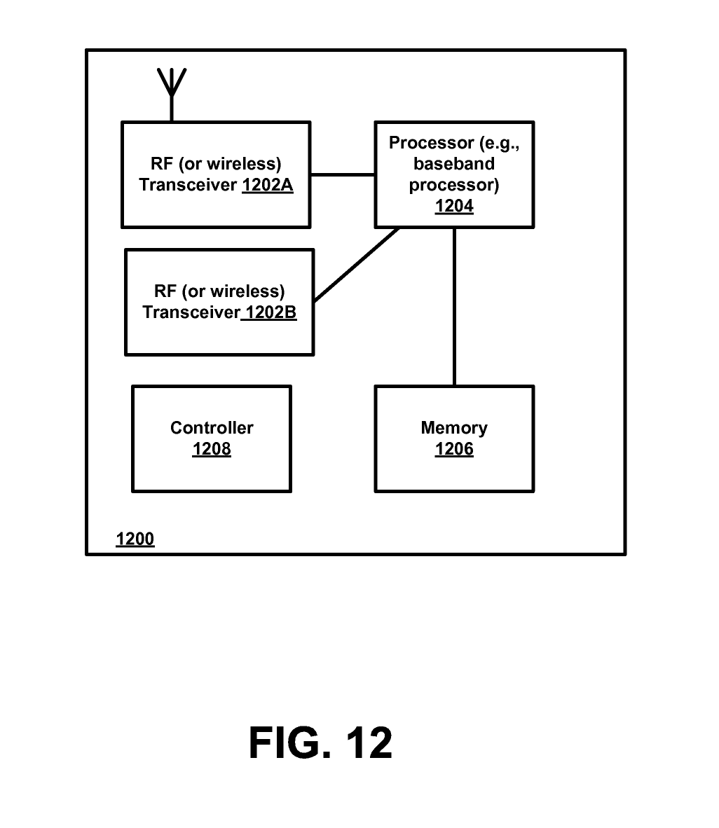

According to another example implementation, an apparatus may include means (e.g., 1202A/1202B and/or 1204, FIG. 12) for receiving, by a mobile station from a cell, a first block of symbols and a second block of symbols, each of the first and second blocks of symbols including a plurality of contiguous segments that include a plurality of symbols; means (e.g., 1202A/1202B and/or 1204, FIG. 12) for performing, by the mobile station, a short correlation of each segment of the first block of symbols with a corresponding segment of the second block of symbols to obtain a plurality of segment correlation results; and means (e.g., 1202A/1202B and/or 1204, FIG. 12) for determining a block correlation result for the first block of symbols and the second block of symbols based on summing at least a first subset of the segment correlation results and subtracting a second subset of the segment correlation results.

According to an example implementation, the apparatus may further include means (e.g., 1202A/1202B and/or 1204, FIG. 12) for determining a synchronization metric based on the block correlation result; and means (e.g., 1202A/1202B and/or 1204, FIG. 12) for receiving, by the mobile station, data from the cell based on the synchronization metric.

According to an example implementation, the means for determining a block correlation result for the first block of symbols and the second block of symbols based on summing at least a first subset of the segment correlation results and subtracting a second subset of the segment correlation results at least reduces a contribution to the block correlation result from one or more spurious signals received by or generated by the mobile station.

According to an example implementation, the means for determining a block correlation result for the first block of symbols and the second block of symbols based on summing at least a first subset of the segment correlation results and subtracting a second subset of the segment correlation results at least reduces a contribution to the block correlation result from one or more spurious signals received by or generated by the mobile station.

According to an example implementation, the apparatus may further include means (e.g., 1202A/1202B and/or 1204, FIG. 12) for at least reducing, by the mobile station, an erroneous contribution of a spurious signal to the block correlation result by at least partially cancelling the spurious signal by summing the spurious signal via summing the first subset of the segment correlation results and subtracting the spurious signal via subtracting the second subset of the segment correlation results.

According to an example implementation, the means for determining a block correlation result may include: means (e.g., 1202A/1202B and/or 1204, FIG. 12) for determining a block correlation result for the first block of symbols and the second block of symbols based on summing a first half of the segment correlation results and subtracting a second half of the segment correlation results, wherein the subtracting the second half of the segment correlation results is performed for segments of one of the blocks that were multiplied by a negative weight before transmission.

According to an example implementation, the means for determining a synchronization metric based on the block correlation result may include: means (e.g., 1202A/1202B and/or 1204, FIG. 12) for determining a synchronization metric as the block correlation result divided by a power value.

According to an example implementation, the apparatus may further include means (e.g., 1202A/1202B and/or 1204, FIG. 12) for limiting a minimum value of the power value.

According to an example implementation, the apparatus may further include means (e.g., 1202A/1202B and/or 1204, FIG. 12) for setting the synchronization metric to zero if the power value is less than a threshold.

According to an example implementation, wherein the means for determining a synchronization metric based on the block correlation result may include means (e.g., 1202A/1202B and/or 1204, FIG. 12) determining a synchronization metric as the block correlation result divided by a maximum power value for the received blocks of symbols.

According to an example implementation, the synchronization metric identifies symbol timing or frame timing at a peak or maximum value of the synchronization metric.

According to another example implementation, an apparatus may include at least one processor and at least one memory including computer instructions, when executed by the at least one processor, cause the apparatus to: receive, by a mobile station from a cell, a first block of symbols and a second block of symbols, each of the first and second blocks of symbols including a plurality of contiguous segments that include a plurality of symbols; determine, by the mobile station, a set of segment weights including a segment weight associated with each of the segments for the second block of symbols, wherein at least one of the segment weights is different from one or more other segment weights in the set of segment weights; multiply each of the segment weights by an associated segment of the second block to obtain weighted segments of the second block; perform, by the mobile station, a short correlation of each segment of the first block of symbols with a corresponding weighted segment of the second block of symbols to obtain a plurality of segment correlation results; and determine a block correlation result for the first block of symbols and the second block of symbols based on summing the segment correlation results.

According to another example implementation, a computer program product may include a computer-readable storage medium and storing executable code that, when executed by at least one data processing apparatus, is configured to cause the at least one data processing apparatus to perform a method including: receiving, by a mobile station from a cell, a first block of symbols and a second block of symbols, each of the first and second blocks of symbols including a plurality of contiguous segments that include a plurality of symbols; determining, by the mobile station, a set of segment weights including a segment weight associated with each of the segments for the second block of symbols, wherein at least one of the segment weights is different from one or more other segment weights in the set of segment weights; multiplying each of the segment weights by an associated segment of the second block to obtain weighted segments of the second block; performing, by the mobile station, a short correlation of each segment of the first block of symbols with a corresponding weighted segment of the second block of symbols to obtain a plurality of segment correlation results; and determining a block correlation result for the first block of symbols and the second block of symbols based on summing the segment correlation results.

According to another example implementation, an apparatus may include means (e.g., 1202A/1202B and/or 1204, FIG. 12) for receiving, by a mobile station from a cell, a first block of symbols and a second block of symbols, each of the first and second blocks of symbols including a plurality of contiguous segments that include a plurality of symbols; means (e.g., 1202A/1202B and/or 1204, FIG. 12) for determining, by the mobile station, a set of segment weights including a segment weight associated with each of the segments for the second block of symbols, wherein at least one of the segment weights is different from one or more other segment weights in the set of segment weights; means (e.g., 1202A/1202B and/or 1204, FIG. 12) for multiplying each of the segment weights by an associated segment of the second block to obtain weighted segments of the second block; means (e.g., 1202A/1202B and/or 1204, FIG. 12) for performing, by the mobile station, a short correlation of each segment of the first block of symbols with a corresponding weighted segment of the second block of symbols to obtain a plurality of segment correlation results; and means (e.g., 1202A/1202B and/or 1204, FIG. 12) for determining a block correlation result for the first block of symbols and the second block of symbols based on summing the segment correlation results.

According to an example implementation, the apparatus may further include means (e.g., 1202A/1202B and/or 1204, FIG. 12) for determining a synchronization metric based on the block correlation result; and means for (e.g., 1202A/1202B and/or 1204, FIG. 12) receiving, by the mobile station, data from the cell based on the synchronization metric.

According to an example implementation, the first block of symbols and the second block of symbols are received by the mobile station in a time order according to one of the following: the first block of symbols is received first in time and the second block of symbols is received second; and the second block of symbols is received first and the first block of symbols is received second.

According to an example implementation, the means for determining, by the mobile station, a set of segment weights may include means (e.g., 1202A/1202B and/or 1204, FIG. 12) for determining a segment weight associated with each of the segments for the second block of symbols, wherein a sum of the set of segment weights is zero.

According to an example implementation, the second block of symbols are provided by a cell as an initial second block of symbols multiplied by a first set of segment weights to provide the second block of symbols received by the mobile station, and wherein the means for determining, by the mobile station, a set of segment weights may include means (e.g., 1202A/1202B and/or 1204, FIG. 12) for determining a second set of segment weights associated with each of the segments for the second block of symbols, wherein each segment weight of the second set of segment weights is a complex conjugate of a corresponding segment weight of the first set of segment weights.

According to another example implementation, an apparatus may include at least one processor and at least one memory including computer instructions, when executed by the at least one processor, cause the apparatus to: determine a set of a plurality of segment weights, wherein a sum of the segment weights is zero; determine a first block of symbols that includes a plurality of segments; determine a second block of symbols that includes a plurality of segments; determine a weighted second block of symbols by multiplying each segment of the second block of symbols by a corresponding weight of the plurality of segment weights; and transmit, by a cell, the first block of symbols and the weighted second block of symbols.

According to another example implementation, a computer program product may include a computer-readable storage medium and storing executable code that, when executed by at least one data processing apparatus, is configured to cause the at least one data processing apparatus to perform a method including: determining a set of a plurality of segment weights, wherein a sum of the segment weights is zero; determining a first block of symbols that includes a plurality of segments; determining a second block of symbols that includes a plurality of segments; determining a weighted second block of symbols by multiplying each segment of the second block of symbols by a corresponding weight of the plurality of segment weights; and transmitting, by a cell, the first block of symbols and the weighted second block of symbols.

According to another example implementation, an apparatus may include means (e.g., 1202A/1202B and/or 1204, FIG. 12) for determining a set of a plurality of segment weights, wherein a sum of the segment weights is zero; means (e.g., 1202A/1202B and/or 1204, FIG. 12) for determining a first block of symbols that includes a plurality of segments; means (e.g., 1202A/1202B and/or 1204, FIG. 12) for determining a second block of symbols that includes a plurality of segments; means (e.g., 1202A/1202B and/or 1204, FIG. 12) for determining a weighted second block of symbols by multiplying each segment of the second block of symbols by a corresponding weight of the plurality of segment weights; and means (e.g., 1202A/1202B and/or 1204, FIG. 12) for transmitting, by a cell, the first block of symbols and the weighted second block of symbols.

According to an example implementation, the apparatus may further include means (e.g., 1202A/1202B and/or 1204, FIG. 12) for transmitting information that indicates the set of segment weights.

According to an example implementation, the first half of the segment weights are a positive value, and a second half of the segment weights are a negative value.

According to an example implementation, the first half of the segment weights are a positive 1 (+1), and a second half of the segment weights are a negative one (−1).

According to an example implementation, the means for transmitting may include means (e.g., 1202A/1202B and/or 1204, FIG. 12) for transmitting, by a cell, the first block of symbols and the weighted second block of symbols via each of a plurality of radio frequency (RF) beams.

FIG. 12 is a block diagram of a wireless station (e.g., BS or user device) 1200 according to an example implementation. The wireless station 1200 may include, for example, two RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 12, a controller (or processor) 1208 may execute software and instructions, and may provide overall control for the station 1200, and may provide control for other systems not shown in FIG. 12, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example implementation, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method of acquiring timing information in a wireless network, the method comprising:
receiving, by a mobile station from a cell, a first block of symbols and a second block of symbols, each of the first and second blocks of symbols including a plurality of contiguous segments that include a plurality of symbols;
performing, by the mobile station, a short correlation of each segment of the first block of symbols with a corresponding segment of the second block of symbols to obtain a plurality of segment correlation results;
determining a block correlation result for the first block of symbols and the second block of symbols based on summing at least a first subset of the segment correlation results and subtracting a second subset of the segment correlation results.

2. The method of claim 1 and further comprising:
determining a synchronization metric based on the block correlation result; and
receiving, by the mobile station, data from the cell based on the synchronization metric.

3. The method of claim 1 wherein the determining a block correlation result for the first block of symbols and the second block of symbols based on summing at least a first subset of the segment correlation results and subtracting a second subset of the segment correlation results at least reduces a contribution to the block correlation result from one or more spurious signals received by or generated by the mobile station.

4. The method of claim 1 and further comprising:
at least reducing, by the mobile station, an erroneous contribution of a spurious signal to the block correlation result by at least partially cancelling the spurious signal by summing the spurious signal via summing the first subset of the segment correlation results and subtracting the spurious signal via subtracting the second subset of the segment correlation results.

5. The method of claim 1 wherein the determining a block correlation result comprises:
determining a block correlation result for the first block of symbols and the second block of symbols based on summing a first half of the segment correlation results and subtracting a second half of the segment correlation results, wherein the subtracting the second half of the segment correlation results is performed for segments of one of the blocks that were multiplied by a negative weight before transmission.

6. The method of claim 2 wherein the determining a synchronization metric based on the block correlation result comprises:
determining a synchronization metric as the block correlation result divided by a power value.

7. The method of claim 6 and further comprising:
limiting a minimum value of the power value.

8. The method of claim 6 and further comprising:
setting the synchronization metric to zero if the power value is less than a threshold.

9. The method of claim 2 wherein the determining a synchronization metric based on the block correlation result comprises:
determining a synchronization metric as the block correlation result divided by a maximum power value for the received blocks of symbols.

10. The method of claim 2 wherein the synchronization metric identifies symbol timing or frame timing at a peak or maximum value of the synchronization metric.

11. The method of claim 2 wherein:
the receiving comprises receiving, by a mobile station from a cell via each of a plurality of radio frequency (RF) beams, a first block of symbols and a second block of symbols, each of the first and second blocks of symbols including a plurality of contiguous segments that include a plurality of symbols;
wherein the performing, determining a block correlation result, and determining a synchronization metric is performed for each of the plurality of RF beams.

12. An apparatus comprising at least one processor and at least one memory including computer instructions, when executed by the at least one processor, cause the apparatus to:
receive, by a mobile station from a cell, a first block of symbols and a second block of symbols, each of the first and second blocks of symbols including a plurality of contiguous segments that include a plurality of symbols;
perform, by the mobile station, a short correlation of each segment of the first block of symbols with a corresponding segment of the second block of symbols to obtain a plurality of segment correlation results; and
determine a block correlation result for the first block of symbols and the second block of symbols based on summing at least a first subset of the segment correlation results and subtracting a second subset of the segment correlation results.

13. A method of acquiring timing information in a wireless network, the method comprising:
receiving, by a mobile station from a cell, a first block of symbols and a second block of symbols, each of the first and second blocks of symbols including a plurality of contiguous segments that include a plurality of symbols;
determining, by the mobile station, a set of segment weights including a segment weight associated with each of the segments for the second block of symbols, wherein at least one of the segment weights is different from one or more other segment weights in the set of segment weights;
multiplying each of the segment weights by an associated segment of the second block to obtain weighted segments of the second block;
performing, by the mobile station, a short correlation of each segment of the first block of symbols with a corresponding weighted segment of the second block of symbols to obtain a plurality of segment correlation results; and
determining a block correlation result for the first block of symbols and the second block of symbols based on summing the segment correlation results.

14. The method of claim 13 and further comprising:
determining a synchronization metric based on the block correlation result; and
receiving, by the mobile station, data from the cell based on the synchronization metric.

15. The method of claim 13, where the first block of symbols and the second block of symbols are received by the mobile station in a time order according to one of the following:
the first block of symbols is received first in time and the second block of symbols is received second; and
the second block of symbols is received first and the first block of symbols is received second.

16. The method of claim 13 wherein the determining, by the mobile station, a set of segment weights comprises determining a segment weight associated with each of the segments for the second block of symbols, wherein a sum of the set of segment weights is zero.

17. The method of claim 13 wherein the second block of symbols are provided by a cell as an initial second block of symbols multiplied by a first set of segment weights to provide the second block of symbols received by the mobile station, and wherein the determining, by the mobile station, a set of segment weights comprises determining a second set of segment weights associated with each of the segments for the second block of symbols, wherein each segment weight of the second set of segment weights is a complex conjugate of a corresponding segment weight of the first set of segment weights.

18. An apparatus comprising at least one processor and at least one memory including computer instructions, when executed by the at least one processor, cause the apparatus to:
receive, by a mobile station from a cell, a first block of symbols and a second block of symbols, each of the first and second blocks of symbols including a plurality of contiguous segments that include a plurality of symbols;
determine, by the mobile station, a set of segment weights including a segment weight associated with each of the segments for the second block of symbols, wherein at least one of the segment weights is different from one or more other segment weights in the set of segment weights;
multiply each of the segment weights by an associated segment of the second block to obtain weighted segments of the second block;
perform, by the mobile station, a short correlation of each segment of the first block of symbols with a corresponding weighted segment of the second block of symbols to obtain a plurality of segment correlation results; and
determine a block correlation result for the first block of symbols and the second block of symbols based on summing the segment correlation results.

19. A method comprising:
determining a set of a plurality of segment weights, wherein a sum of the segment weights is zero;
determining a first block of symbols that includes a plurality of segments;
determining a second block of symbols that includes a plurality of segments;
determining a weighted second block of symbols by multiplying each segment of the second block of symbols by a corresponding weight of the plurality of segment weights; and
transmitting, by a cell, the first block of symbols and the weighted second block of symbols.

20. The method of claim 19 and further comprising:
transmitting information that indicates the set of segment weights.

21. The method of claim 19 wherein first half of the segment weights are a positive value, and a second half of the segment weights are a negative value.

22. The method of claim 19 wherein first half of the segment weights are a positive 1 (+1), and a second half of the segment weights are a negative one (−1).

23. The method of claim 19 wherein the transmitting comprises:
transmitting, by a cell, the first block of symbols and the weighted second block of symbols via each of a plurality of radio frequency (RF) beams.
